(19) United States
(12) Patent Application Publication
(10) Pub. No.: US 2010/0057554 A1
(43) Pub. Date: Mar. 4, 2010

(54) Method and System for Enabling Promotion of Product(s) and/or Service(s)

(75) Inventor: Matthew Lanford, London (GB)

Correspondence Address: RYAN, MASON & LEWIS, LLP, 1300 POST ROAD, SUITE 205, FAIRFIELD, CT, 06824, US

(73) Assignee: MasterCard International Incorporated, Purchase, NY (US)

(21) Appl. No.: 12/553,499

(22) Filed: Sep. 3, 2009

Related U.S. Application Data
(60) Provisional application No. 61/094,255, filed on Sep. 4, 2008.

(51) Int. Cl. G06Q 30/00; G06Q 20/00; G06F 15/16; G06Q 40/00

(52) U.S. Cl. 705/14.38; 709/206

(57) ABSTRACT

At least one promotional program manager provides a plurality of merchants with a list of item identifiers for a plurality of items eligible for a promotion, and a list of device identifying numbers of payment devices associated with the promotion. A given one of the merchants identifies, during a putative purchase transaction with a given one of the payment devices, at least one of the plurality of items eligible for the promotion. The given one of the merchants, and an acquiring entity, cooperatively format and dispatch an authorization request. The authorization request is sent to an issuing entity of the given one of the payment devices, via an operator of a payment network. The authorization request includes a given one of the device identifiers associated with the given one of the prepaid payment devices, a given one of the item identifiers associated with the at least one of the plurality of items eligible for the promotion, and price data associated with the at least one of the plurality of items eligible for the promotion. The issuing entity prepares and sends an authorization request response to the authorization request. The authorization request response is sent from the issuing entity to the merchant, via the operator of the payment network and the acquiring entity. The authorization request response indicates whether the putative purchase of the at least one of the plurality of items eligible for the promotion with the given one of the prepaid payment devices is approved. The method further includes the promotional program manager applying the promotion to the given eligible item.

### CROSS-REFERENCE TO RELATED APPLICATIONS

This patent application claims the benefit of U.S. Povisional Patent Application Ser. No. 61/094,255 filed Sep. 4, 2008 and entitled “Method and System For Enabling Promotion Of Product(s) And/Or Service(s)” of inventor Matthew Lanford. The disclosure of the aforementioned Provisional Patent Application Ser. No. 61/094,255 is expressly incorporated herein by reference in its entirety for all purposes.

### FIELD OF THE INVENTION

The present invention relates generally to electronic commerce, and, more particularly, to electronic payment systems.

### BACKGROUND OF THE INVENTION

It is known to use payment cards, such as credit cards, debit cards, cards which hold a balance, and the like, to make payments. Typically, in approving transactions with such cards, the total requested amount is approved or disapproved, depending on whether the card holder has a sufficient balance or credit line, as the case may be. It is also known to employ products such as pre-paid cards for the purpose of promoting products and/or services, and the like.

### SUMMARY OF THE INVENTION

Principles of the present invention provide techniques for enabling promotion of product(s) and/or service(s). An exemplary embodiment of a method (which can be computer-implemented), according to one aspect of the invention, includes the steps of facilitating at least one promotional program manager (for example, an issuer or issuer processor) providing a plurality of merchants with a list of item identifiers for a plurality of items eligible for a promotion, and a list of device identifying numbers of payment devices associated with the promotion. Furthermore, the method also includes facilitating a given one of the merchants identifying, during a putative purchase transaction with a given one of the payment devices, at least one of the plurality of items eligible for the promotion. In addition, the method includes facilitating the given one of the merchants, and an acquiring entity, cooperatively formatting and dispatching an authorization request. The authorization request is sent to an issuing entity of the given one of the payment devices, via an operator of a payment network. The authorization request includes a given one of the device identifiers associated with the given one of the prepaid payment devices. The authorization request also includes a given one of the item identifiers associated with the at least one of the plurality of items eligible for the promotion, as well as price data associated with the at least one of the plurality of items eligible for the promotion. The method further includes facilitating the issuing entity preparing and sending an authorization request response to the authorization request. The authorization request response is sent from the issuing entity to the merchant, via the operator of the payment network and the acquiring entity. The authorization request response indicates whether the putative purchase of the at least one of the plurality of items eligible for the promotion with the given one of the prepaid payment devices is approved (for example, based on whether there is adequate money in a promotional purse or account). The method further includes the promotional program manager applying the promotion to the given eligible item.

In another aspect, an exemplary method, from the point of view of the issuer, issuer processor, or program manager, includes sending, from the promotional program manager to a plurality of merchants, a list of item identifiers for a plurality of items eligible for a promotion; sending, from the promotional program manager to the plurality of merchants, a list of device identifying numbers of payment devices associated with the promotion; and receiving, from a given one of the merchants, and an acquiring entity, an authorization request for a putative transaction, via an operator of a payment network. The authorization request includes a given one of the device identifiers associated with a given one of the payment devices presented in connection with the putative transaction, a given one of the item identifiers associated with at least one of the plurality of items, from the putative transaction, eligible for the promotion, and price data associated with the at least one of the plurality of items eligible for the promotion. An additional step includes preparing and sending an authorization request response to the authorization request. The authorization request response is sent to the merchant, via the operator of the payment network and the acquiring entity. The authorization request response indicates whether the putative purchase, of the at least one of the plurality of items eligible for the promotion, with the given one of the payment devices, is approved. A further step includes applying the promotion to the at least one of the plurality of items eligible for the promotion.

An exemplary issuer platform may include, for example, a memory, an issuer platform software module embodied on a tangible, computer-readable, recordable storage medium, and at least one hardware processor, operative to execute the issuer platform software module when loaded into the memory, so as to carry out one or more of the method steps just described.

An overall system to implement one or more method steps may include the issuer platform, a virtual private payment network coupled to the issuer platform, and a plurality of merchant point of sale systems coupled to the virtual private payment network.

Aspects of the invention contemplate the method(s) performed by one or more entities herein, as well as facilitating (as defined below) of one or more method steps by the same or different entities.

One or more embodiments of the invention or elements thereof can be implemented in the form of a computer product including a tangible computer readable recordable storage medium with computer usable program code for performing the method steps indicated. Furthermore, one or more embodiments of the invention or elements thereof can be implemented in the form of a system (or apparatus) including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s), or (iii) a combination of hardware and software modules; any of (i)-(iii) implement the specific techniques set forth herein, and the software modules are stored in a tangible computer-readable recordable storage medium (or multiple such media).

One or more embodiments of the invention can provide substantial beneficial technical effects.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows a general example of a payment system that can implement techniques of the invention;

FIG. 2 shows exemplary data flow;

FIG. 3 is a flow chart of an exemplary method;

FIG. 4 is a flow chart of another exemplary method;

FIG. 5 is a block diagram of an exemplary computer system useful in one or more embodiments of the present invention;

FIG. 6 is a flow chart of yet another exemplary method;

FIG. 7 shows non-limiting exemplary technical details of ISO 8583 DE 124, member defined data, which can be employed in one or more embodiments;

FIG. 8 shows non-limiting exemplary technical details of ISO 8583 DE 124, subelement 25, which can be employed in one or more embodiments;

FIG. 9 shows exemplary implementation impacts of one specific non-limiting embodiment on a merchant and/or acquirer and an issuer and/or issuer processor;

FIG. 10 depicts an exemplary inter-relationship between and among: (i) a payment network configured to facilitate transactions between multiple issuers and multiple acquirers, (ii) a plurality of users, (iii) a plurality of providers or other merchants, (iv) a plurality of acquirers, and (v) a plurality of issuers; and

FIG. 11 shows an exemplary issuer platform, according to an aspect of the invention.

### DETAILED DESCRIPTION OF PREFERRED EMBODIMENTS

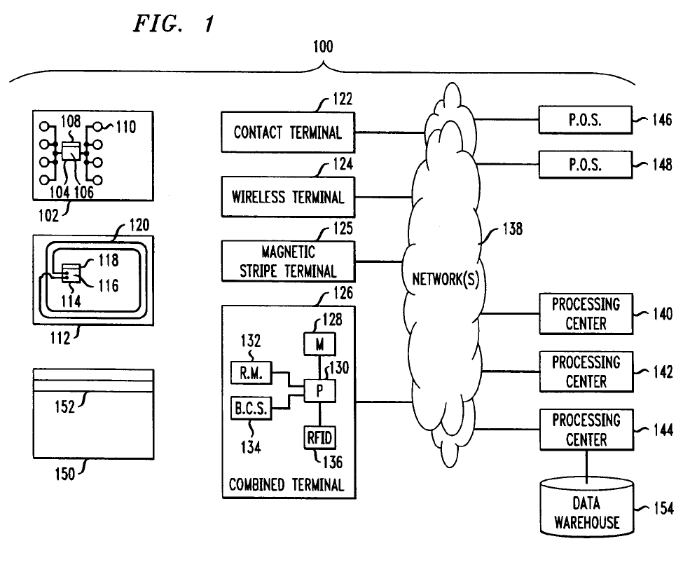

Attention should now be given to FIG. 1, which depicts an exemplary embodiment of a system 100, according to an aspect of the invention, and including various possible components of the system. System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed with techniques of the invention. Other types of devices used in lieu of or in addition to “smart” or “chip” cards 102, 112 could include a conventional card 150 having a magnetic stripe 152, an appropriately configured cellular telephone handset, and the like. Indeed, techniques of the invention can be adapted to a variety of different types of cards, terminals, and other devices.

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's primary account number (“PAN”) and/or personal identification number (“PIN”). The memory portions or units 108, 118 can store the operating system of the cards 102, 112. The operating system loads and executes applications and provides file management or other basic card services to the applications. One operating system that can be used to implement the present invention is the MULTOS® operating system licensed by MAOSCO Limited. (MAOSCO Limited, St. Andrews House, The Links, Kelvin Close, Birchwood, Warrington, WA37PB, United Kingdom) Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications. At present, one possible specification to which such applications may conform is the EMV interoperable payments specification set forth by EMVCo, LLC (901 Metro Center Boulevard, Mailstop M3-3D, Foster City, Calif., 94404, USA). It will be appreciated that applications can be configured in a variety of different ways.

As noted, cards 102, 112 are examples of a variety of payment devices that can be employed with techniques of the invention. The primary function of the payment devices may not be payment, for example, they may be cellular phone handsets that implement techniques of the invention. Such devices could include cards having a conventional form factor, smaller or larger cards, cards of different shape, key fobs, personal digital assistants (PDAs), appropriately configured cell phone handsets, or indeed any device with the capabilities to implement techniques of the invention. In some cases, the cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to execute one or more method steps. The applications can be, for example, application identifiers (AIDs) linked to software code in the form of firmware plus data in a card memory such as an electrically erasable programmable read-only memory (EEPROM). Again, note that “smart” or “chip” cards are not necessarily required and a conventional magnetic stripe card can be employed.

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any type of device 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network. More than one network could be employed to connect different elements of the system. For example, a local area network (LAN) could connect a terminal to a local server or other computer at a retail establishment. A payment network could connect acquirers and issuers. Further details regarding one specific form of payment network will be provided below. Processing centers 140, 142, 144 can include, for example, a host computer of an issuer of a payment device.

Many different retail or other establishments, represented by points-of-sale 146, 148, can be connected to network 138. In one or more embodiments of the invention, it is believed preferable that various establishments interface with a telecommunications network, such as a virtual private network (VPN), via one or more machines which are then connected to the network. This will be discussed further below. Each such establishment can have one or more terminals. Further, different types of portable payment devices, terminals, or other elements or components can combine or “mix and match” one or more features depicted on the exemplary devices in FIG. 1.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to perform one or more steps of methods and techniques. The processor can perform such operations via hardware techniques, and/or under the influence of program instructions, such as an application, stored in one of the memory units.

The portable device can include a body portion. For example, this could be a laminated plastic body (as discussed above) in the case of “smart” or “chip” cards 102, 112, or the handset chassis and body in the case of a cellular telephone.

Again, conventional magnetic stripe cards 150 can be used instead of or together with “smart” or “chip” cards.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module such as 132 that is coupled to the processor and configured to interface with the portable apparatuses 102, 112, 142. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138. The aforementioned bar code scanner 134 and/or RFID tag reader 136 can be provided, and can be coupled to the processor, to gather attribute data, such as a product identification, from a UPC code or RFID tag on a product to be purchased.

The above-described devices 102, 112 can be ISO 7816-compliant contact cards or devices or NFC (Near Field Communications) or ISO 14443-compliant proximity cards or devices. In operation, card 112 can be touched or tapped on the terminal 124 or 128, which then contactlessly transmits the electronic data to the proximity IC chip in the card 112 or other wireless device.

One or more of the processing centers 140, 142, 144 can include a database such as a data warehouse 154.

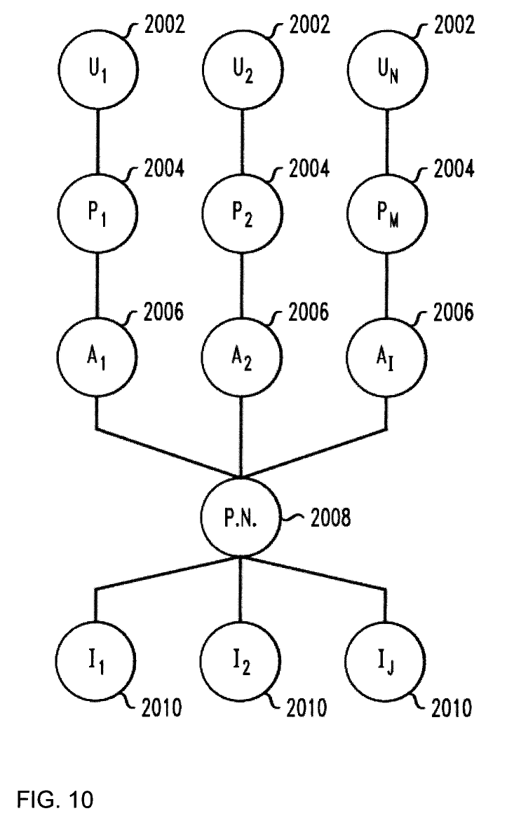

With reference to FIG. 10, an exemplary relationship among multiple entities is depicted. A number of different users 2002, U₁, U₂ . . . U_{N}, interact with a number of different merchants 2004, P₁, P₂ . . . P_{M}. Users 2002 could be, for example, holders of prepaid promotional cards. Merchants 2004 interact with a number of different acquirers 2006, A₁, A₂ . . . A_{I}. Acquirers 2006 interact with a number of different issuers 2010, I₁, I₂ . . . I_{J}, through, for example, a single operator 2008 of a payment network configured to facilitate transactions between multiple issuers and multiple acquirers; for example, MasterCard International Incorporated, operator of the BANKNET® network, or Visa International Service Association, operator of the VISANET® network. In general, N, M, I, and J are integers that can be equal or not equal.

During a conventional credit authorization process, the cardholder 2002 pays for the purchase and the merchant 2004 submits the transaction to the acquirer (acquiring bank) 2006. The acquirer verifies the card number, the transaction type and the amount with the issuer 2010 and reserves that amount of the cardholder's credit limit for the merchant. Authorized transactions are stored in “batches,” which are sent to the acquirer 2006. During clearing and settlement, the acquirer sends the batch transactions through the credit card association, which debits the issuers 2010 for payment and credits the acquirer 2006. Once the acquirer 2006 has been paid, the acquirer 2006 pays the merchant 2004. One or more embodiments of the invention make use of pre-paid cards, wherein the card-holder spends money which has been “stored” via a prior deposit (for example, by or on behalf of an entity carrying out a promotion of one or more products and/or services). Such pre-paid cards typically carry a credit-card brand (such as, for example, MasterCard brand, Visa brand, American Express brand, or Discover brand) and can be used in similar ways (a so-called open loop or branded approach). Instead of checking a purchase against an available credit limit, it can be checked against the available stored balance. In other embodiments, closed loop, limited loop, or non-branded (private label) cards or devices, such as pre-paid cards, could be employed, wherein the cards or devices are accepted at only one, or a few, but not all retailers or other merchants.

It will be appreciated that the network 2008 shown in FIG. 10 is an example of a payment network configured to facilitate transactions between multiple issuers and multiple acquirers, which may be thought of as an “open” system. Some embodiments of the invention may be employed with other kinds of payment networks, for example, proprietary or closed payments networks with only a single issuer and acquirer, such as the AMERICAN EXPRESS network (mark of American Express Company).

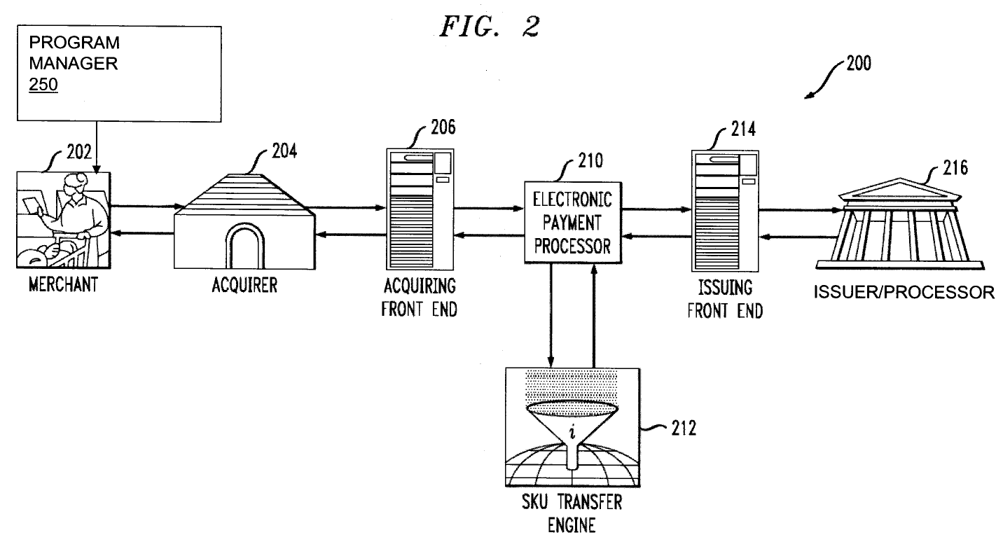

Attention should now be given to FIG. 2, which is a block diagram 200 of one possible specific exemplary embodiment of the invention, also depicting (via the arrows) data flow according to the exemplary embodiment. In some instances, an architecture depicted in US Patent Publication No. 2008-0011820 of Brown et al., entitled “Method and System for Enabling Item-Level Approval of Payment Card” is modified to implement one or more techniques or aspects of the invention. The complete disclosure of the aforesaid US Patent Publication No. 2008-0011820 is expressly incorporated herein by reference in its entirety for all purposes.

As shown at 202, the holder of a card or other payment device interacts with a terminal at a point of interaction, such as a facility of a merchant or other card acceptor, corresponding, e.g., to terminals and points of sale as described with respect to FIG. 1. The card acceptor sends transaction information to an acquirer 204 (equivalent to acquirer 2006 in FIG. 10), for example, via a network such as described in FIG. 1 or as described in FIG. 10. The merchant can provide indicia such as stock keeping unit (SKU) numbers, universal product codes (UPCs), and/or national drug codes (NDCs). “SKU” is a common term for a unique numeric identifier, used most commonly in online business to refer to a specific product in inventory or in a catalog. The indicia can be provided in an authorization request. A front end processor 206 can be provided between acquirer 204 and electronic payment processor 210 (e.g., a virtual private network (VPN) of a single operator of a payment network 2008 configured to facilitate transactions between multiple issuers and multiple acquirers, or a third party acting on behalf of such an operator). Front end processor 206 can be located in a variety of places, e.g., at the acquirer's facility. One example of a suitable front end processor 206 is a MASTERCARD INTERFACE PROCESSOR™ or MIP™ processor (trademarks of MasterCard International, Inc. of Purchase, N.Y.). The acquirer 204 should preferably be a split tender acquirer, as will be discussed more fully hereinafter.

The skilled artisan will of course appreciate that in this context, “processor” 210 means, e.g., an entity 2008 having a VPN or other network, and the like, while “processor” 206, 214 means a more specific piece of hardware.

The acquirer 204 can forward the indicia, for example, via processor 206, payment network 210, and issuer front end processor 214, to issuer (or issuer processor) 216, which is equivalent to issuer or issuer processor 2010 in FIG. 10. In US Patent Publication No. 2008-0011820, and in some instances of the present invention, the indicia can be first forwarded to a transfer engine 212. The transfer engine is depicted in FIG. 2 as an “SKU Transfer Engine” but it should be understood that it can process a wide variety of indicia as discussed herein. Engine 212, in some cases, receives the authorization request and translates the indicia into a form understandable by issuer or issuer processor 216 or a party acting in connection with the issuer or issuer processor; for example, an administrator such as a Third Party Administrator, program manager, or the like. The translated indicia can be populated into the authorization request, which is then forwarded by engine 212 to block 216. This forwarding can be via payment network 210. In general terms, block 216 can represent, for example, an issuer of a card used by the consumer, or a party acting on behalf of such issuer.

It should be noted that the translation functionality described herein is optional. It may be useful, for example, where a number of different products are eligible for promotion, to translate any non-standard merchant indicia into a UPC or other indicia understandable by the issuer, issuer processor, program manager, and the like.

Block 214 can represent, for example, another front-end processor, such as a MIP , and can be located, e.g., at the facility of an issuer or other administrator 216 to provide access to the aforementioned VPN of processor 210. Of course, there may be a plurality of similarly-equipped issuer, and other, facilities. Furthermore, it is to be emphasized that the specific configuration shown in FIG. 2 is exemplary in nature. Other approaches can be employed.

Issuer/processor 216 can match the indicia (translated, if necessary) against a database containing, for example, lists of eligible items under a given promotional scheme, can approve individual values, and can sum the approved amount. The approved amount can be provided in a response message to be returned to the merchant 202 through the reverse of the path just described, as shown by the return arrows. Note that in at least some instances, the issuer/processor may maintain a database listing eligible items, while the engine 212 may maintain a database for translation.

Front end processors, such as processor 206, 214, and VPNs, such as the VPN of processor 210, are well-known to skilled artisans. In one specific example, the processors 206, 214 are (as noted) MIP™ processors, and the VPN of processor 210 is a telecommunications network providing MASTERCARD BANKNET® telecommunications network services (registered trademark of MasterCard International, Inc. of Purchase, N.Y.).

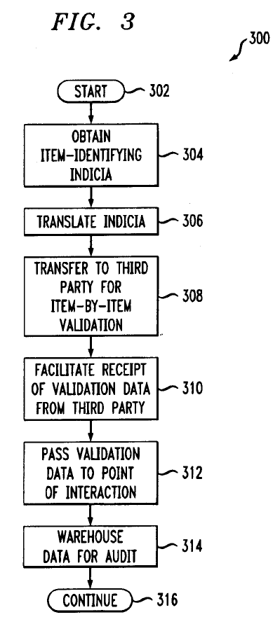

FIG. 3 presents a flow chart 300 of method steps for electronic payment validation, adapted from US Patent Publication No. 2008-0011820. After beginning at block 302, at step 304, a step of facilitating obtaining indicia identifying individual items to be purchased at a point of interaction, in conjunction with an inbound authorization request, can be conducted. The indicia can include, e.g., SKUs, UPCs, NDCs, and the like. The individual items to be purchased can include products and/or services. The point of interaction can be any place where the transaction takes place, e.g., a retail merchant, etc. The flow in FIG. 3 is presented from the perspective of payment network 210 with optional transfer engine such as element 212, and the inbound authorization request is thus inbound from acquirer 204. As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed.

Optional step 306 includes facilitating translation of the indicia into a form understandable by issuer 216 or related third party transaction approver, to obtain translated indicia. Step 308 includes facilitating transfer of the (optionally, translated) indicia to the third party transaction approver for item-by-item validation on the individual items. The transfer of the translated indicia is in conjunction with an outbound authorization request (e.g., outbound from network 210 and optionally engine 212 to block 216).

Further possible steps include steps 310 and 312. Step 310 includes facilitating receipt of validation data associated with the item-by-item validation on the individual items from the third party transaction approver. The data could include, for example, a total sum approved and/or item-by-item approvals. The item-by-item validation is based at least on matching of the (optionally, translated) indicia against a database. Note, in one or more embodiments, even when only a total approved sum is included in the data, items are still validated by issuer 216 on an item-by-item basis. Step 312 includes facilitating passage of the validation data in a response message to be routed to the point of interaction.

As noted, the validation data can include a total approved monetary amount reflecting a total price of those of the items that are valid. The total approved monetary amount is no greater than the total purchase price of the individual items to be purchased (inclusive of any appropriate tax, as will be discussed further hereinafter). In another aspect, the validation data comprises flags for each of the individual items, and the flags indicate whether a given one of the items is valid. If desired, both a total approved amount and flags can be included.

For the avoidance of doubt, one or more embodiments of the present invention address promotional items, and so do not necessarily involve approving individual items, but rather address sending the indicia so that the issuer (or issuer processor or program manager) has the ability to perform promotional processes such as collecting points for purchased items, authorizing the transaction for the item but not charging the cardholder, (such as buy one get one free, or 5^{th} purchase is free), and the like. Thus, aspects of US Patent Publication No. 2008-0011820 pertain to limiting what someone can buy, based on a list of approved or authorized products; whereas certain aspects of the present invention pertain to the case where a person purchases many items, some of which are eligible for a promotion, but without necessarily restricting the allowable spending based on the product indicia.

In step 304, the indicia identifying the individual items may be obtained, in conjunction with the inbound authorization request, from a split-tender acquirer (a split-tender acquirer is one having a capability to pass back to a merchant from whom the items are to be purchased a total approved monetary amount that is less than the amount in the inbound authorization request).

Optional step 314 includes warehousing (e.g., in a data warehouse such as 154) at least the translated indicia and the validation data for audit. This step could be of interest to check compliance with a program. Suitable privacy protections should, of course, be implemented.

The user can be prompted to pay for disapproved items via cash, check, another payment card, etc. Processing continues at block 316. Again, aspects of US Patent Publication No. 2008-0011820 pertain to only allowing approved items to be purchased, whereas certain aspects of the present invention involve the ability to identify promotion items being purchased and performing some action if the promotional item is purchased.

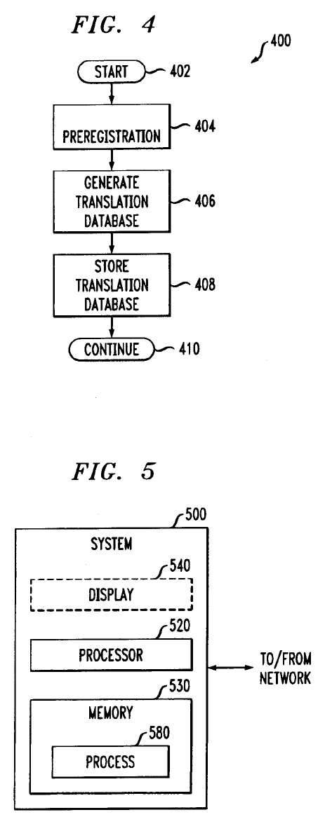

FIG. 4 shows a flow chart 400 of an exemplary method, which can be computer-implemented, for building a database useful in facilitating electronic payment validation. At this point it should be noted that while the methods described with regard to FIGS. 3 and 4 can be computer-implemented, in one or more exemplary embodiments, they may also include one or more manual steps, or a combination of manual and computer-aided steps. After beginning at block 402, step 404 includes facilitating obtaining, via pre-registration of, for example, merchants, program managers, and/or issuers, indicia (e.g., SKU, UPC, drug code, and the like) identifying individual promotion-eligible items. In some cases, indicia differ, among given merchants, for an identical one of the promotional items to be purchased. That is, by way of example, Smith's Pharmacy and Baker's Pharmacy may use different SKUs for an identical package of adhesive bandages; two different groceries or convenience stores night use different SKUs for the identical promotional item (say, a bottle of juice), and so on. In another aspect, a candy company might offer a promotion based on purchase of any of a range of different candy products. Each package might have a different UPC value, for example. The engine 212 could be used to translate the individual candy bar package UPC values to a single value that the issuer, issuer processor, or promotion manager could receive.

Step 406 includes facilitating generating a translation database having a single translated indicia associated with each given one of the items, regardless of whether given ones of the merchants have different indicia associated with the given one of the items. That is, the package of adhesive bandages is identified by a single unique (translated) identifier, regardless of the fact that Smith and Baker each use a different identifier for it. In the alternative example, all the UPCs of the candy bars eligible for promotion could be translated to a single unique identifier.

Step 408 includes facilitating storage of the translation database in a form to facilitate ready translation of a given indicia into a corresponding translated indicia, based on the given indicia and an identity a given one of the merchants associated with the given indicia. That is, given the identity of the merchant and its SKU for the product, the universal identifier can be looked up so that the issuer or other third party can render an approve/disapprove decision.

Processing continues at step 410.

For purposes of illustrative convenience, not every block in FIGS. 3 and 4 includes the word “facilitate,” but it will be understood that the method depicted broadly include facilitation of the indicated actions as well as their actual performance. The same is true of the other flow charts herein.

By way of summary and provision of additional detail, in some instances, the inbound authorization request discussed above can contain information that includes the cost per item and the identity of the item. To sum the properly approved amount, such information can also include sales tax or value added tax (VAT) information. This cost and tax information need not be in the database maintained by the issuer or other third party approver. Cost for each item need not be included in the translation database, but may be passed to the engine 212 from the merchant in the authorization request along with the indicia. Quantity can come into play in some cases (e.g., limited amount of promotional products available) and could be passed in the authorization request to the issuer or other third party approver. The issuer or other third party would then make decisions at the per-item level based on the data provided in the authorization request. While cost of the item need not be part of the decision, it could be taken into account.

It will be appreciated that one or more exemplary embodiments of the invention can provide one or more advantages; for example, reducing or eliminating the need for a third party approver to maintain multiple data tables, thus resulting in faster processing time. Such reduced processing time may be enabled, in one or more embodiments, via the inventive translation database.

In another aspect, a system, method, and/or computer program product facilitate promotion of product(s) and/or service(s); for example, using a pre-paid promotional payment card or device. One or more embodiments enable merchants 202, 2004 to pass item-level data of potentially eligible promotional merchandise in the authorization message, giving the issuer or processor the control to approve the transaction at the line-item level and/or to direct amounts to specific “purses” on the prepaid promotional card. In one or more instances, prepaid program managers (block 250 in FIG. 2; may be connected with issuer/processor 216) provide a list of eligible promotional product identifiers (by way of example and not limitation, UPC or SKU) to participating merchants 202. Merchants 202 flag these promotional items in their inventory management systems. In addition, prepaid program managers will provide merchants with the participating bank identification numbers (BINs) and merchants will load these BINs into their point-of-sale (POS) systems (for example, terminals 122, 124, 125, 126, or servers connected thereto). The prepaid program manager functionality could be implemented, by way of example and not limitation, by block 216 or another entity (block 250) in communication with the merchant 202.

The term issuer can refer to the issuer 216, 2010 of a card or other payment device. Reference to the issuer/processor encompasses acts performed by the issuer, and/or one or more parties acting on behalf of the issuer, as will be appreciated by the skilled artisan from the context; in one or more embodiments, the issuer processor is a third party who performs required issuer processing on behalf of the issuer.

As used herein, a “prepaid payment card” refers to a card or other device (e.g., appropriately configured cellular phone handset) configured according to a credit or debit card type payment system standard or specification, wherein a stored balance associated with the card resides on a central or remote server, which prepaid payment card is designed for use in a conventional credit or debit card environment (for example, of the kind as shown in FIG. 10), and which is nearly universally accepted worldwide by merchants of all kinds. Such a card is also distinguished from a credit or debit card, in that it accesses a balance on a central server rather than a credit account or bank account. Furthermore, a debit card typically implies an established banking relationship with the cardholder (for example, an existing checking account) and is not anonymous, whereas a pre-paid card may (but need not be) purchased anonymously in a shop (it could be obtained from a bank in some circumstances, for example).

One or more embodiments of the invention are not limited to prepaid payment cards, but may also include stored value cards, credit cards, and/or debit cards, in any combination or individually. In a stored value card, the balance is maintained on-card; for example, in a chip. A credit card may be thought of as a credit access device to access an unsecured line of credit. A debit card may be thought of as an access device to access a bank account. A prepaid payment card is not primarily associated with a bank account or unsecured line of credit in this fashion.

As used herein, a promotional card is a debit, credit, prepaid, or stored value card or other payment device, wherein an identifier such as a BIN or IIN is linked to a promotional scheme, such that the cardholder has the ability to receive promotional incentives on one or more consumer products or services. Promotional cards, such as prepaid promotional cards, can, in some cases, be given to cardholders by the company who is promoting the products or services as a method of redeeming the promotion or collecting points to be redeemed for product at a later time.

When a cardholder presents a participating card (or other device) to the merchant 202 (equivalent to merchant 2004) for payment of his or her purchase, the merchant 202 will determine if any eligible promotional products are being purchased. If any eligible promotional products are being purchased with a participating card, the merchant will pass the identifier (by way of example and not limitation, UPC or SKU) of those items in the authorization message. Upon receiving the authorization message, the issuer processor will authorize the transaction based on available funds in the account(s) and/or “purses(s)”. The issuer/processor 216 uses the identifier passed by the merchant 202 to determine the pertinent account “purse” and the amount to post to such pertinent “purse.” If supported by the merchant 202, the issuer/processor may partially approve the transaction for only the total eligible promotional products amount. In the event of a partial approval, the merchant 202 will then perform a split tender transaction to collect the remaining amount of the total transaction (for example, by asking the customer to provide cash, check, or a different payment card or device for the balance due).

In one or more embodiments, the merchant 202 will accept a file of eligible promotional items from the issuer and/or issuer processor and the merchant will update its inventory management system as necessary. The merchant will also accept a file of eligible BINs from the issuer and/or issuer processor and will update its POS systems (e.g., terminals 122, 124, 125, and/or 126 located at a POS 146, 148, possibly including other processing capability coupled to the terminals, such as a server or the like) to recognize these BINs as requiring specialized processing.

Certain exemplary embodiments will now be described. Some such embodiments make use of ISO 8583, which is essentially open and used by MasterCard International Incorporated, Visa International Service Association, other networks, terminals, and so on. Furthermore, one or more exemplary embodiments mention user-defined data element(s) such as DE 124, as well as a subelement 25 thereof. It is to be emphasized that these specific details are purely for illustrative purposes. Other embodiments might convey the same, similar, or other information using the same elements and/or subelements, different elements and/or subelements, or even a standard or specification other than ISO 8583.

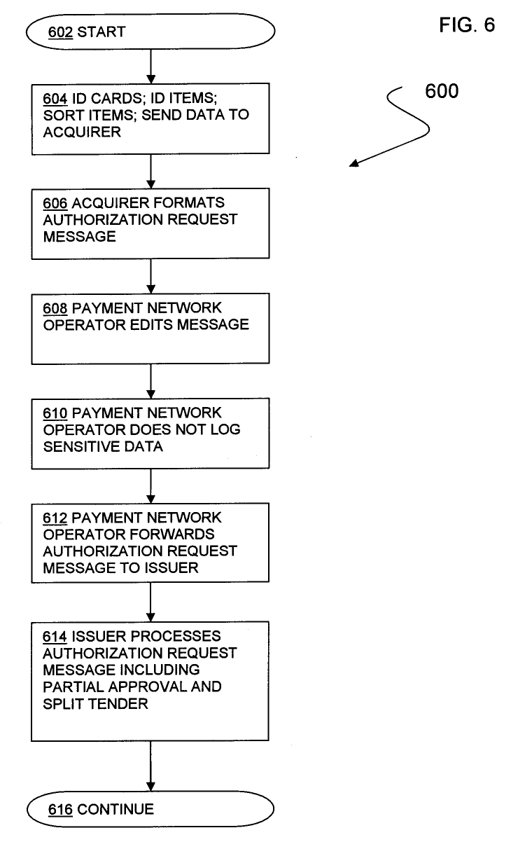

An exemplary, non-limiting process for a promotional transaction will now be described with reference to flow chart 600 of FIG. 6. After beginning in step 602, in step 604, the merchant 202 identifies participating cards by “Bank Identification Numbers” (BINs) or “Issuer Identification Numbers” (IINs) received from the issuer processor. The merchant will identify eligible items based on item identifiers (e.g., UPC, SKU) agreed with the issuer processor. The merchant will sort potential eligible items to the top (of the register receipt, e.g.). These items should be included in the data sent to the acquirer 204. In at least some instances, this sorting is a merchant-only function, and the merchant's interaction with the acquirer is otherwise conventional. The items will be identified with the Promotional Item Identifier Type, the Promotional Item Identifier, and the Promotional Item Extended Amount, including the applicable tax for the item. In some instances, the promotion is implemented within a scheme that may be referred to by the terminology “PETS,” used as a shorthand for promotion enhanced transaction services, a non-limiting exemplary form of method, computer program product, and/or system for enabling promotion of product(s) and/or services(s), according to one or more aspects of the invention.

In step 606, the acquirer 204 formats the Authorization Request/0100 message with DE (data element) 124 (the skilled artisan is familiar with DE 124 and with ISO-defined data elements in general, and, given the teachings herein, can adapt same to implement one or more embodiments of the invention). Note that in some cases, implementations conform to pertinent ISO standards, such as ISO 8583. Individual entities or groups may develop specifications within this standard. In a non-limiting embodiment, some or all messages (for example, authorization request and response) are defined within ISO 8583 and/or within a specification conforming thereto. Other types of messages could be used in other instances. All versions (e.g., 1987, 1993, 2003) of the ISO 8583 Standard for Financial Transaction Card Originated Messages—Interchange message specifications, promulgated by the International Organization for Standardization, are expressly incorporated herein by reference in their entirety fro all purposes.

In step 608, the operator of a network operating according to a payment system standard (and/or specification), such as MasterCard International Incorporated of Purchase, N.Y., USA (BANKNET® network), will validate (edit) the Authorization Request/0100 message using current authorization system edits. The skilled artisan will appreciate that “editing” by a payment network operator typically includes validation and format verification of the fields (for example, in some instances, the promotional item identifier type must be either “S” for SKU or “U” for UPC; any value other than “S” or “U” is flagged as erroneous). If an incorrect value is found, the transaction may be rejected back to the merchant. The contents of DE 124 will be forwarded to the issuer without change. Note that MasterCard International Incorporated of Purchase, N.Y., USA is a non-limiting example of such a payment network operator, but it will be understood that other entities, such as other operators of networks operating according to a payment system standard (and/or specification); e.g., Visa International Service Association, operator of the VISANET® network, could also perform one or more steps or techniques, or implement one or more systems and/or computer program products. Furthermore, one or more embodiments may be applicable to proprietary networks such as that operated by American Express Company, and/or to closed loop networks.

As noted, examples herein are non-limiting; message 0100 is specific to the BANKNET network but message 0200 for the MasterCard Debit Switch (MDS) product could be employed, or completely different messages could be employed in other networks.

As indicated at step 610, appropriate respect and compliance are preferably implemented for all applicable rules, regulations, policies, procedures, and/or standards pertaining to privacy and the like. Thus, in a preferred approach, the payment network operator does not log any Promotional Approval Data; instead, the same is replaced, for example, with the value “PETS xxx” where xxx is the total length of DE 124 and PETS is representative of some kind of flag for the promotional program (in this non-limiting exemplary instance, referring to the aforementioned promotion enhanced transaction services).

As indicated in step 612, the payment network operator 210 forwards the authorization Request/0100 message to the issuer/processor for processing. As in step 614, the issuer/processor processes the Authorization Request/0100 message. DE 124 hould preferably not be returned in the Authorization Request Response/0110 message. Partial approvals are preferably supported. Processing continues in block 616.

The issuer and/or issuer processor preferably provide the merchant with a file containing the identifier (e.g., UPC, SKU) information of the promotional items. This is typically the same as the information provided by the program manager 250. Program manager 250 is typically the issuer. A non-limiting exemplary file format is set forth below, it being understood that mandatory items might be optional in other implementations and vice versa:

| | ITEM | FORMAT | BITS | REQUIRED? |
|---|---|---|---|---|
| 1 | UPC or SKU | ans-12, left-justified, | 5-16 | Mandatory |
| | | space filled | | |
| 2 | Category Code | ans-4 | 1-4 | Optional |
| 3 | Description | ans-100, left-justified, | 17-116 | Mandatory |
| | | space filled | | |
| 4 | Filler | ans-34 | 117-150 | * |

* Please note that “Filler” refers to filling with blank spaces (an unused area).

In one or more embodiments, the issuer will send this file when the implementation of the promotional functionality begins and then as needed. In at least some instances, the full file can be sent each time. In one or more embodiments, an item list file (by way of example and not limitation, a list of eligible promotional items, and the like) will be sent. One non-limiting example of such an item list file is a promotional items list file of items on promotion, wherein the issuer, issuer processor, or program manager advises the merchant that when there is a putative purchase of items on the list, with a card on the card list, the merchant needs to send the item identifier (e.g., SKU or UPC) to the issuer, issuer processor, or program manager. The promotional item list file is somewhat analogous to a healthcare item list file in the healthcare context. In addition, the issuer and/or issuer processor will provide the merchant with the participating BINs or IINs.

In one or more embodiments, implementations of promotional functionality as disclosed herein do not require changing any current message layouts.

The following information provides exemplary technical details for DE 124 (Member-defined data) which may be used in one or more non-limiting embodiments of the invention.

DE 124 data representation is preferably updated to show (i) prepaid promotional approval data, which in one or more embodiments is referred to as MasterCard Prepaid PETS Approval Data, as well as (ii) an indication of the type and length of the data field(s). The skilled artisan will appreciate that DE 124 is used to submit up to 500 bytes of member-defined data. Members may use DE 124 to transmit information such as, by way of example and not limitation:
Loyalty program information
Promotional information
Details about a purchase
Healthcare eligibility inquiry information
Any other business-related data
prepaid promotional approval data, such as MasterCard Prepaid PETS Approval data

Given the teachings herein, the skilled artisan will be able to employ DE 124 to transmit required or desired information.

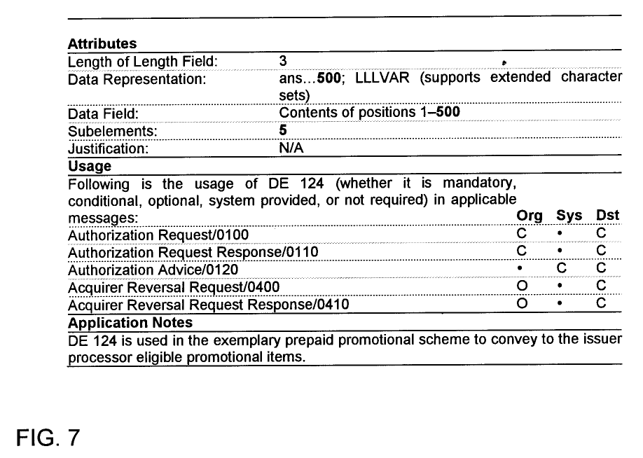

Preferably, one member (e.g., of a payment network or the like) should not send another member an authorization message containing data in DE 124 unless both members previously arranged to receive an authorization message with data in DE 124. The table of FIG. 7 depicts non-limiting exemplary characteristics of DE 124 that may be employed in one or more embodiments. Note that “ans” denotes alpha-numeric signed; “500” denotes the (maximum) number of bytes in the field, and “LLLVAR” refers to an instance where the first three bytes of the field refer to the length of the field and the field is of variable length. Furthermore, “Org” refers to origination; “Sys” refers to system (i.e., the operator of the payment network); and “Dst” refers to destination. In addition, “C” refers to conditional, a dot refers to not required; and “O” refers to optional. Thus, with regard to the Authorization Request/0100, the originator sends the DE124 only if there is some value to be included in it; the system takes no action with respect to it, and the destination receives it conditionally (i.e., only if it was sent).

### Subelement 25—Prepaid Promotional Approval Data

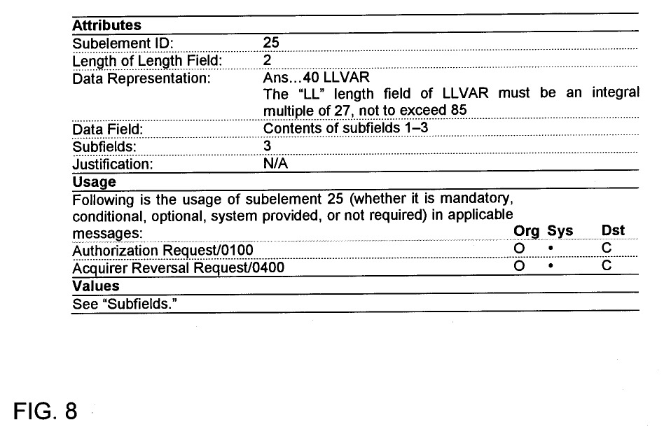

In one or more embodiments, subelement 25 contains potentially eligible promotional items only. There may be multiple occurrences of subelement 25; in one or more embodiments, not to exceed five. Each occurrence of subelement 25 has, in one or more embodiments, a maximum length of 85. In one or more instances, there may be up to three promotional items within each occurrence of subelement 25, and the maximum number of items that may be submitted in an Authorization Request/0100 message is 15. Each promotional item submitted for approval preferably has three subfields. The table of FIG. 8 depicts non-limiting exemplary characteristics of Subelement 25 that may be employed in one or more embodiments. The notation in FIG. 8 is generally similar to FIG. 7; “40” denotes the (maximum) number of bytes in the field, and “LLVAR” refers to an instance where the first two bytes of the field refer to the length of the field and the field is of variable length.

### Subfield 1—PETS Identifier Type

This subfield identifies the type of identifier sent. Note that an-1 means alpha-numeric, one byte.

| | |
|---|---|
| Attributes | |
| Data Representation: | an-1 |
| Data Field: | Contents of position 1 |
| Justification: | N/A |
| Values | |
| S = | Merchant SKU |
| U = | Product UPC |

### Subfield 2—PETS Item Identifier

This subfield includes the merchant's item identifier. If subfield 1=S, the data represents the (SKU) value from the merchant's inventory control system. If subfield 1=U, the data represents the manufacturer's UPC product value. Note that ans-20 means alpha-numeric signed, twenty bytes.

| | |
|---|---|
| Attributes | |
| Data Representation: | ans-20 |
| Data Field: | Contents of positions 2-21 |
| Justification: | Left-justified, trailing spaces |
| Values | |

### Subfield 3—PETS Extended Item Amount

This subfield includes the total extended amount for the item in subfield 2. Note that n-9 means numeric, six bytes.

| | |
|---|---|
| Attributes | |
| Data Representation: | n-6 |
| Data Field: | Contents of positions 22-27 |
| Justification: | Right-justified, leading zeros |
| Values | |

Total extended amount for the item in subfield 2. If three boxes of swabs
cost $1.00 each, the extended amount is $3.35 (000335) with an 11.67%
tax rate. The extended amount must include the tax.

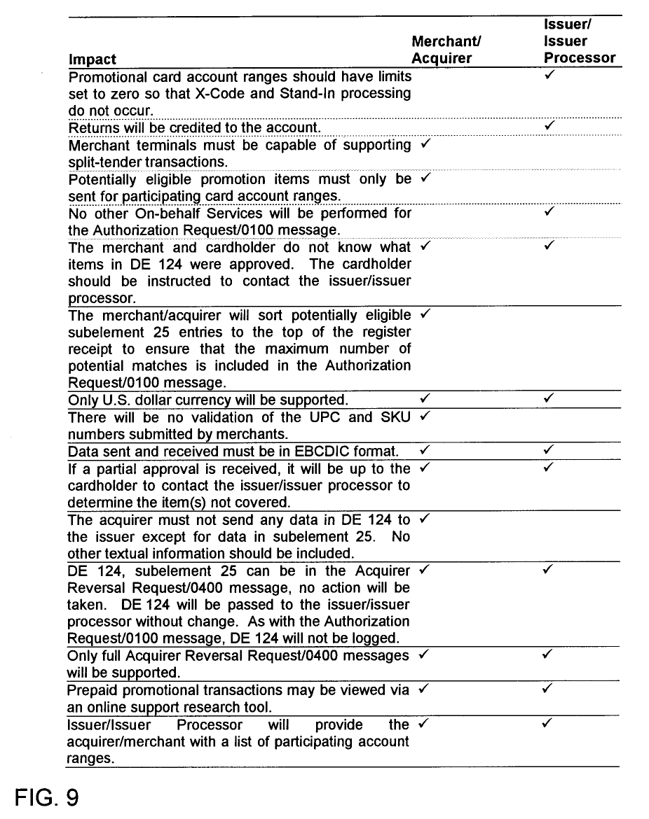

In one or more embodiments, the acquirer and/or merchant and issuer and/or issuer processor should understand the impact statements in FIG. 9, in addition to the previously identified requirements. These items are exemplary, and refer to a specific non-limiting embodiment—other embodiments may differ (e.g., other currencies can be supported; parties can have different knowledge regarding approvals, subject to compliance with applicable privacy rules, regulations, policies, and/or procedures; different data formats or validation requirements can be implemented; and so on). Note that a non-limiting example of an online support research tool is the MasterCard eService™ tool (mark of MasterCard International Incorporated, Purchase, N.Y., USA).

Note that the examples presented herein are not intended to be limiting; for example, in other embodiments, items referred to herein as mandatory may be optional.

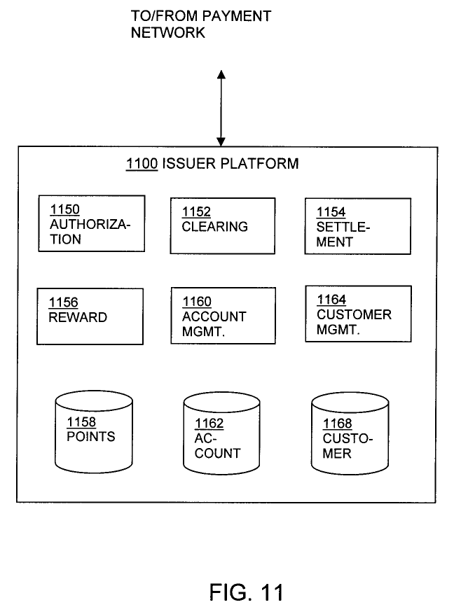

Referring to FIG. 11, the issuer, issuer processor, or program manager may employ an issuer platform 1100, which can include, for example, authorization, clearing, and settlement functionality 1150, 1152, and 1154. Reward functionality 1156 may interact with a reward data store, such as a reward point data store 1158. Account management functionality 1160 may interact with an account data store 1162. Customer management functionality 1164 may interact with a customer data store 1168. Issuer platform 1100 may interact with an acquirer platform of acquirer 204, 2006 via payment network 210, 2008. ISO 8583 messaging may be employed, for example.

The operator of the payment network 210, 2008 enables the issuer by transmitting the required item-level data. Furthermore, in at least some instances, the file containing the list of card identifiers (e.g., BINs or IINs) and/or the file containing the list of eligible items can be sent to the merchant over the VPN payment network (although in other approaches, the file(s) could be sent over the Internet, on physical media, and so on).

Given the description thus far, it will be appreciated that, in general terms, an exemplary method, according to an aspect of the invention, includes the step of facilitating at least one promotional program manager (for example, an issuer or issuer processor) providing a plurality of merchants with a list of item identifiers for a plurality of items eligible for a promotion, as in step 604 of FIG. 6. The method further includes facilitating the at least one promotional program manager providing the plurality of merchants with a list of device identifying numbers of payment devices associated with the promotion, also as per step 604 of FIG. 6. These steps could include, for example, sending a file or files from platform 1100 to a point-of-sale system of a merchant (e.g., terminals 122, 124, 125, 126 at a point of sale 146, 148 connected to a server by a LAN or WAN or the like). Furthermore, the method also includes facilitating a given one of the merchants identifying, during a putative purchase transaction with a given one of the payment devices, at least one of the plurality of items eligible for the promotion, also as per step 604 of FIG. 6. This step might involve, for example, using the scanner 134 or RFID device 136 to obtain indicia from the item and compare same to a list in the terminal or on a server associated with the terminal.

In addition, the method includes facilitating the given one of the merchants, and an acquiring entity, cooperatively formatting and dispatching an authorization request, as in steps 604 and 606 of FIG. 6. An acquiring entity includes an acquirer and/or an acquirer processor acting on behalf of the acquirer. This step could be carried out, for example, with the aid of an acquirer platform. The authorization request is sent to an issuing entity of the given one of the payment devices, via an operator of a payment network 210, 2008, as per step 612 of FIG. 6. An issuing entity includes an issuer and/or an issuer processor acting on behalf of the issuer. The authorization request includes a given one of the device identifiers (for example, BIN or IIN as part of PAN) associated with the given one of the prepaid payment devices. The authorization request also includes a given one of the item identifiers (for example, SKU or UPC) associated with the at least one of the plurality of items eligible for the promotion, as well as price data associated with the at least one of the plurality of items eligible for the promotion.

The method further includes facilitating the issuing entity preparing and sending an authorization request response to the authorization request, as in step 614 of FIG. 6. The authorization request response is sent from the issuing entity (for example, using issuer platform 1100) to the merchant, via the operator of the payment network and the acquiring entity. The authorization request response indicates whether the putative purchase of the at least one of the plurality of items eligible for the promotion with the given one of the prepaid payment devices is approved (for example, based on whether there is adequate money in a promotional purse or account). The method further includes the promotional program manager applying the promotion to the given eligible item. This could include, for example, incrementing points database 1158; applying a discount, or the like. In some embodiments, the discount is implemented by only posting the discounted price, e.g., if the promotion is “buy one get one free,” approval is for the price of two items but then only the price of one item is posted to the customer's account, so the customer only pays for one item and on the statement only sees a charge for one item.

The method may in some cases be implemented, for example, using the architecture shown in FIG. 2, which may be, for example, a version of the architecture shown in US Patent Publication No. 2008-0011820, modified in accordance with the teachings herein. Where the optional translation feature was desired, the engine 212 could be used to carry out the translation.

In at least some instances, an additional step includes the operator of the payment network editing the authorization request without logging the given one of the item identifiers associated with the at least one of the plurality of items eligible for the promotion, as in steps 608 and 610 of FIG. 6. As noted, the skilled artisan will appreciate that “editing” by a payment network operator typically includes validation of the fields (for example, in some instances, the promotional item identifier type must be either “S” for SKU or “U” for UPC; any value other than “S” or “U” is flagged as erroneous). This step may be carried out by a computer or the like within the payment network.

In one or more instances, the putative purchase transaction with the given one of the payment devices includes at least one ineligible item not eligible for the promotion, and an additional step includes the given one of the merchants sorting the at least one of the plurality of items eligible for the promotion ahead of the at least one ineligible item on a register receipt associated with the putative purchase transaction, as in step 604 of FIG. 6. In such cases, the authorization request may include a total amount which in turn includes (i) an extended price (price plus tax) for the at least one of the plurality of items eligible for the promotion, reflected in the price data; and (ii) an extended price for the at least one ineligible item. Furthermore, in such cases, the authorization request response may further reflect approval of an approved amount less than the total amount, due to disapproval of the at least one ineligible item.

As shown in step 614 of FIG. 6, in some instances, an additional step includes facilitating the given one of the merchants initiating a split tender transaction for the total amount less the approved amount.

One or more embodiments include repeating the steps of facilitating identifying, facilitating formatting and dispatching, and facilitating preparing and sending, for at least another putative purchase transaction of another given one of the items eligible for the promotion. In such cases, a promotional balance of the given one of the payment devices could be less than an extended price of the other given one of the items eligible for the promotion, and the authorization request response could indicate approval of an approved amount equal to the prepaid promotional balance.

As noted above, in some instances, there may be multiple purses. Thus, in some cases, the putative purchase transaction of the at least one of the plurality of items eligible for the promotion is authorized against a first purse of the given one of the prepaid payment devices, and the given one of the prepaid payment devices has at least a second purse. In such instances, an additional step can include charging at least one item not eligible for the promotion against the second purse.

A non-limiting example of a prepaid program manager is an issuing entity. A non-limiting example of a payment device is a prepaid payment card. A non-limiting example of a device identifier includes a bank identification number.

In some instances, the payment network is of a kind wherein a single operator facilitates transactions between multiple issuers and multiple acquirers, as shown in FIG. 10.

Additional optional steps include facilitating inventory management systems of the plurality of merchants flagging the plurality of items eligible for the promotion, based on the list of item identifiers; and/or facilitating point of sale systems of the plurality of merchants flagging the payment devices associated with the promotion, based on the list of device identifying numbers. In some cases, an additional step includes determining whether the given one of the payment devices is associated with the promotion (for example, based on its BIN/IIN), and the given one of the item identifiers is included in the authorization request message in response to determining that the given one of the payment devices is associated with the promotion.

As noted, the given one of the item identifiers could be, for example, a UPC or an SKU; in any case, the authorization request may further include an item identifier type indicating that the given one of the item identifiers is a UPC or SKU, as the case may be.

Translation can also be carried out, as described above.

Viewed from the point of view of the issuer, issuer processor, or program manager, an exemplary method includes sending, from the promotional program manager to a plurality of merchants, a list of item identifiers for a plurality of items eligible for a promotion; sending, from the promotional program manager to the plurality of merchants, a list of device identifying numbers of payment devices associated with the promotion; and receiving, from a given one of the merchants, and an acquiring entity, an authorization request for a putative transaction, via an operator of a payment network. The authorization request includes a given one of the device identifiers associated with a given one of the payment devices presented in connection with the putative transaction, a given one of the item identifiers associated with at least one of the plurality of items, from the putative transaction, eligible for the promotion, and price data associated with the at least one of the plurality of items eligible for the promotion. An additional step includes preparing and sending an authorization request response to the authorization request. The authorization request response is sent to the merchant, via the operator of the payment network and the acquiring entity. The authorization request response indicates whether the putative purchase, of the at least one of the plurality of items eligible for the promotion, with the given one of the payment devices, is approved. A further step includes applying the promotion to the at least one of the plurality of items eligible for the promotion.

Issuer platform 1100 may include, for example, a memory, an issuer platform software module embodied on a tangible, computer-readable, recordable storage medium, and at least one hardware processor, operative to execute the issuer platform software module when loaded into the memory, so as to carry out the method steps described.

An overall system to implement one or more method steps may include the issuer platform, a virtual private payment network coupled to the issuer platform, and a plurality of merchant point of sale systems coupled to the virtual private payment network.

### System and Article of Manufacture Details

The invention can employ hardware and/or hardware and software aspects. Software includes but is not limited to firmware, resident software, microcode, etc. Software might be employed, for example, in connection with one or more of a terminal 122, 124, 125, 126, a front end processor 206, 214, a transfer engine 212, or a processing center 140, 142, 144 (optionally with data warehouse 154) of a merchant, issuer, acquirer, processor, or operator of a network 210, 2008 operating according to a payment system standard (and/or specification). It is presently believed that engine 212 can be advantageously implemented, e.g., in software running on a general purpose computer. Software running on a computer can also be used for building the database as shown in FIG. 4, for building lists as in FIG. 6 and 11, implementing issuer and/or acquirer platforms, and so on. Firmware might be employed, for example, in connection with payment devices such as cards 102, 112.

FIG. 5 is a block diagram of a system 500 that can implement part or all of one or more aspects or processes of the present invention. As shown in FIG. 5, memory 530 configures the processor 520 (which could correspond, e.g., to processor portions 106, 116, 130, processors of elements 206-214 and 250, or processors of remote hosts in centers 140, 142, 144) to implement one or more aspects of the methods, steps, and functions disclosed herein (collectively, shown as process 580 in FIG. 5). Different method steps can be performed by different processors. The memory 530 could be distributed or local and the processor 520 could be distributed or singular. The memory 530 could be implemented as an electrical, magnetic or optical memory, or any combination of these or other types of storage devices (including memory portions as described above with respect to cards 102, 112). It should be noted that if distributed processors are employed, each distributed processor that makes up processor 520 generally contains its own addressable memory space. It should also be noted that some or all of computer system 500 can be incorporated into an application-specific or general-use integrated circuit. For example, one or more method steps could be implemented in hardware in an ASIC rather than using firmware. Display 540 is representative of a variety of possible input/output devices.

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a computer system, to carry out all or some of the steps to perform the methods or create the apparatuses discussed herein. A computer-usable medium may, in general, be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). For example, one device could be a physical memory media associated with a terminal and another device could be a physical memory media associated with a processing center. As used herein, a tangible computer-readable recordable storage medium is intended to encompass a recordable medium, examples of which are set forth above, but is not intended to encompass a transmission medium or disembodied signal.

The computer systems and servers described herein each contain a memory that will configure associated processors to implement the methods, steps, and functions disclosed herein. Such methods, steps, and functions can be carried out, e.g., by processing capability on elements 102, 112, 122, 124, 125, 126, 140, 142, 144, 206-214, 250 or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the invention, such as, for example, the aforementioned terminals 122, 124, 125, 126, processing centers 140, 142, 144 with data warehouse 154, processors and/or engine(s) 206-214 and 50, or payment devices such as cards 102, 112 can make use of computer technology with appropriate instructions to implement method steps described herein. By way of further example, a terminal apparatus 122, 124, 125, 126 could include, inter alia, a communications module, an antenna coupled to the communications module, a memory, and at least one processor coupled to the memory and the communications module and operative to interrogate a contactless payment device (in lieu of the antenna and communications module, appropriate contacts and other elements could be provided to interrogate a contact payment device such as a contact card or read a magnetic stripe). By way of yet a further example, an apparatus for electronic payment validation (such as engine 212), an issuer platform or an acquirer platform, and/or an apparatus for building a database useful in facilitating electronic payment validation, could include a memory and at least one processor coupled to the memory. The memory could load appropriate software. The processor can be operative to perform one or more method steps described herein (e.g., in FIGS. 3, 4 and/or 6) or otherwise facilitate their performance.

Accordingly, it will be appreciated that one or more embodiments of the invention can include a computer program comprising computer program code means adapted to perform one or all of the steps of any methods or claims set forth herein when such program is run on a computer, and that such program may be embodied on a computer readable medium. Further, one or more embodiments of the present invention can include a computer comprising code adapted to cause the computer to carry out one or more steps of methods or claims set forth herein, together with one or more apparatus elements or features as depicted and described herein.

As used herein, including the claims, a “server” includes a physical data processing system (for example, system 500 as shown in FIG. 5) running a server program. It will be understood that such a physical server may or may not include a display, keyboard, or other input/output components.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components shown in the figures. In one or more embodiments, the modules include an issuer platform module (for example, running on one or more hardware processors of an issuer host), and optionally a transfer engine software module, optionally with a translation database and/or an approved promotional item database._The method steps can then be carried out using the distinct software modules of the system, as described above, executing on the one or more hardware processors. Further, a computer program product can include a tangible computer-readable recordable storage medium with code adapted to be executed to carry out one or more method steps described herein, including the provision of the system with the distinct software modules.

Computers discussed herein can be interconnected, for example, by one or more of network 210, another virtual private network (VPN), the Internet, a local area and/or wide area network (LAN and/or WAN), via an EDI layer, and so on. The computers can be programmed, for example, in compiled, interpreted, object-oriented, assembly, and/or machine languages, for example, one or more of C, C++, Java, Visual Basic, and the like (an exemplary and non-limiting list), and can also make use of, for example, Extensible Markup Language (XML), known application programs such as relational database applications, spreadsheets, and the like. The computers can be programmed to implement the logic depicted in the flow charts.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising the steps of:
facilitating at least one promotional program manager providing a plurality of merchants with a list of item identifiers for a plurality of items eligible for a promotion;
facilitating said at least one promotional program manager providing said plurality of merchants with a list of device identifying numbers of payment devices associated with said promotion;
facilitating a given one of said merchants identifying, during a putative purchase transaction with a given one of said payment devices, at least one of said plurality of items eligible for said promotion;
facilitating said given one of said merchants, and an acquiring entity, cooperatively formatting and dispatching an authorization request to an issuing entity of said given one of said payment devices, via an operator of a payment network, said authorization request comprising at least:
a given one of said device identifiers associated with said given one of said payment devices;
a given one of said item identifiers associated with said at least one of said plurality of items eligible for said promotion; and
price data associated with said at least one of said plurality of items eligible for said promotion;
facilitating said issuing entity preparing and sending an authorization request response to said authorization request, said authorization request response being sent from said issuing entity to said merchant, via said operator of said payment network and said acquiring entity, said authorization request response indicating whether said putative purchase, of said at least one of said plurality of items eligible for said promotion, with said given one of said payment devices, is approved; and
facilitating said promotional program manager applying said promotion to said at least one of said plurality of items eligible for said promotion.

2. The method of claim 1, further comprising said operator of said payment network editing said authorization request without logging said given one of said item identifiers associated with said at least one of said plurality of items eligible for said promotion.

3. The method of claim 2, wherein said putative purchase transaction with said given one of said payment devices includes at least one ineligible item not eligible for said promotion, further comprising said given one of said merchants sorting said at least one of said plurality of items eligible for said promotion ahead of said at least one ineligible item on a register receipt associated with said putative purchase transaction.

4. The method of claim 3, wherein:
said authorization request includes a total amount comprising:
an extended price for said at least one of said plurality of items eligible for said promotion, reflected in said price data; and
an extended price for said at least one ineligible item;
said authorization request response further reflects approval of an approved amount less than said total amount, due to disapproval of said at least one ineligible item.

5. The method of claim 4, further comprising facilitating said given one of said merchants initiating a split tender transaction for said total amount less said approved amount.

6. The method of claim 4, further comprising repeating said steps of facilitating identifying, facilitating formatting and dispatching, and facilitating preparing and sending, for at least another putative purchase transaction of another given one of said items eligible for said promotion, wherein a promotional balance of said given one of said payment devices is less than an extended price of said another given one of said items eligible for said promotion, and wherein said authorization request response indicates approval of an approved amount equal to said promotional balance.

7. The method of claim 1, wherein said putative purchase transaction of said at least one of said plurality of items eligible for said promotion is authorized against a first purse of said given one of said payment devices, said given one of said payment devices having at least a second purse, further comprising charging at least one item not eligible for said promotion against said second purse.

8. The method of claim 1, wherein said at least one program manager comprises said issuing entity.

9. The method of claim 1, wherein said given one of said payment devices comprises a prepaid payment card.

10. The method of claim 1, wherein said given one of said device identifiers comprises a bank identification number.

11. The method of claim 1, wherein said payment network is of a kind wherein a single operator facilitates transactions between multiple issuers and multiple acquirers.

12. The method of claim 1, further comprising facilitating inventory management systems of said plurality of merchants flagging, in said inventory management systems, said plurality of items eligible for said promotion, based on said list of item identifiers.

13. The method of claim 1, further comprising facilitating point of sale systems of said plurality of merchants flagging, in said point of sale systems, said payment devices associated with said promotion, based on said list of device identifying numbers.

14. The method of claim 13, further comprising determining whether said given one of said payment devices is associated with said promotion, wherein said given one of said item identifiers is included in said authorization request message in response to determining that said given one of said payment devices is associated with said promotion.

15. The method of claim 1, wherein said given one of said item identifiers comprises a universal product code, and wherein said authorization request further comprises an item identifier type indicating that said given one of said item identifiers comprises said universal product code.

16. The method of claim 1, wherein said given one of said item identifiers comprises a stock keeping unit number, and wherein said authorization request further comprises an item identifier type indicating that said given one of said item identifiers comprises said stock keeping unit number.

17. The method of claim 1, further comprising translating said given one of said item identifiers.

18. A method comprising the steps of:
sending, from a promotional program manager to a plurality of merchants, a list of item identifiers for a plurality of items eligible for a promotion;
sending, from said promotional program manager to said plurality of merchants, a list of device identifying numbers of payment devices associated with said promotion;
receiving, from a given one of said merchants, and an acquiring entity, an authorization request for a putative transaction, via an operator of a payment network, said authorization request comprising at least:
a given one of said device identifiers associated with a given one of said payment devices presented in connection with said putative transaction;
a given one of said item identifiers associated with at least one of said plurality of items, from said putative transaction, eligible for said promotion; and
price data associated with said at least one of said plurality of items eligible for said promotion;
preparing and sending an authorization request response to said authorization request, said authorization request response being sent to said merchant, via said operator of said payment network and said acquiring entity, said authorization request response indicating whether said putative purchase, of said at least one of said plurality of items eligible for said promotion, with said given one of said payment devices, is approved; and
applying said promotion to said at least one of said plurality of items eligible for said promotion.

19. A system comprising:
means for facilitating at least one promotional program manager providing a plurality of merchants with a list of item identifiers for a plurality of items eligible for a promotion;
means for facilitating said at least one promotional program manager providing said plurality of merchants with a list of device identifying numbers of payment devices associated with said promotion;
means for facilitating a given one of said merchants identifying, during a putative purchase transaction with a given one of said payment devices, at least one of said plurality of items eligible for said promotion;
means for facilitating said given one of said merchants, and an acquiring entity, cooperatively formatting and dispatching an authorization request to an issuing entity of said given one of said payment devices, via an operator of a payment network, said authorization request comprising at least:
a given one of said device identifiers associated with said given one of said payment devices;
a given one of said item identifiers associated with said at least one of said plurality of items eligible for said promotion; and
price data associated with said at least one of said plurality of items eligible for said promotion;
means for facilitating said issuing entity preparing and sending an authorization request response to said authorization request, said authorization request response being sent from said issuing entity to said merchant, via said operator of said payment network and said acquiring entity, said authorization request response indicating whether said putative purchase, of said at least one of said plurality of items eligible for said promotion, with said given one of said payment devices, is approved; and
means for facilitating said promotional program manager applying said promotion to said at least one of said plurality of items eligible for said promotion.

20. An issuer platform comprising:
a memory;
an issuer platform software module embodied on a tangible, computer-readable, recordable storage medium; and
at least one hardware processor, operative to execute said issuer platform software module when loaded into said memory, so as to:
sending, to a plurality of merchants, a list of item identifiers for a plurality of items eligible for a promotion;
sending, to said plurality of merchants, a list of device identifying numbers of payment devices associated with said promotion;
receiving, from a given one of said merchants, and an acquiring entity, an authorization request for a putative transaction, via an operator of a payment network, said authorization request comprising at least:
a given one of said device identifiers associated with a given one of said payment devices presented in connection with said putative transaction;
a given one of said item identifiers associated with at least one of said plurality of items, from said putative transaction, eligible for said promotion; and
price data associated with said at least one of said plurality of items eligible for said promotion;
prepare and send an authorization request response to said authorization request, said authorization request response being sent to said merchant, via said operator of said payment network and said acquiring entity, said authorization request response indicating whether said putative purchase, of said at least one of said plurality of items eligible for said promotion, with said given one of said payment devices, is approved; and
apply said promotion to said at least one of said plurality of items eligible for said promotion.

21. The issuer platform of claim 20, wherein:
said putative purchase transaction with said given one of said payment devices includes at least one ineligible item not eligible for said promotion;
said authorization request includes a total amount comprising:
an extended price for said at least one of said plurality of items eligible for said promotion, reflected in said price data; and
an extended price for said at least one ineligible item;
said authorization request response further reflects approval of an approved amount less than said total amount, due to disapproval of said at least one ineligible item; and
said at least one hardware processor is further operative to repeating said steps of receiving, and preparing and sending, for at least another putative purchase transaction of another given one of said items eligible for said promotion, wherein a promotional balance of said given one of said prepaid payment devices is less than an extended price of said another given one of said items eligible for said promotion, and wherein said authorization request response indicates approval of an approved amount equal to said promotional balance.

22. The issuer platform of claim 20, wherein said putative purchase transaction of said at least one of said plurality of items eligible for said promotion is authorized against a first purse of said given one of said payment devices, said given one of said payment devices having at least a second purse, wherein said at least one hardware processor is further operative to charge at least one item not eligible for said promotion against said second purse.

23. A system comprising:
an issuer platform comprising a memory, an issuer platform software module embodied on a tangible, computer-readable, recordable storage medium, and at least one hardware processor, operative to execute said issuer platform software module when loaded into said memory;
a virtual private payment network coupled to said issuer platform; and
a plurality of merchant point of sale systems coupled to said virtual private payment network;
wherein:
said issuer platform provides said plurality of merchant point of sale systems with a list of item identifiers for a plurality of items eligible for a promotion;
said issuer platform provides said plurality of merchant point of sale systems with a list of device identifying numbers of payment devices associated with said promotion;
a given one of said merchant point of sale systems identifies, during a putative purchase transaction with a given one of said payment devices, at least one of said plurality of items eligible for said promotion;
said given one of said merchant point of sale systems facilitates formatting and dispatching an authorization request to said issuer platform, via said virtual private payment network, said authorization request comprising at least:
a given one of said device identifiers associated with said given one of said payment devices;
a given one of said item identifiers associated with said at least one of said plurality of items eligible for said promotion; and
price data associated with said at least one of said plurality of items eligible for said promotion;
said issuer platform prepares and sends an authorization request response to said authorization request, said authorization request response being sent from said issuer platform to said merchant, via said virtual private payment network, said authorization request response indicating whether said putative purchase, of said at least one of said plurality of items eligible for said promotion, with said given one of said payment devices, is approved; and
said issuer platform applies said promotion to said at least one of said plurality of items eligible for said promotion.

24. The system of claim 23, wherein said given one of said device identifiers comprises a bank identification number.

25. The system of claim 23, wherein said virtual private payment network is of a kind wherein a single operator facilitates transactions between multiple issuers and multiple acquirers.
